(19) United States
(12) Patent Application Publication
(10) Pub. No.: US 2026/0011757 A1
(43) Pub. Date: Jan. 8, 2026

(54) FUEL-CELL EXHAUST SYSTEM, FUEL CELL SYSTEM AND METHOD FOR REDUCING THE WATER CONTENT IN FUEL-CELL EXHAUST GAS

(71) Applicant: Purem GmbH, Neunkirchen (DE)

(72) Inventors: Peter Wink, Uhingen (DE); Tobias Lehr, Esslingen (DE); Markus Birgler, Wernau (DE); Jochen Hammer, Stuttgart (DE)

(21) Appl. No.: 19/260,083

(22) Filed: Jul. 3, 2025

(30) Foreign Application Priority Data
Jul. 5, 2024 (DE) 10 2024 119 111.2

(51) Int. Cl. H01M 8/04119; H01M 8/04014; H01M 8/0662

(52) U.S. Cl. CPC H01M 8/04164; H01M 8/04014; H01M 8/0662

(57) ABSTRACT

A fuel-cell exhaust system for a fuel cell system includes a heat exchanger arrangement with a first heat exchanger area, through which fuel-cell exhaust gas can flow, and a second heat exchanger area, through which cooling gas can flow, the first heat exchanger area and the second heat exchanger area being in heat transfer interaction for transferring heat from the fuel-cell exhaust gas to the cooling gas, and a mixing arrangement for receiving cooled fuel-cell exhaust gas discharged from the first heat exchanger area and heated cooling gas discharged from the second heat exchanger area in a mixing volume for producing a mixture of cooled fuel-cell exhaust gas and heated cooling gas and for discharging the mixture.

### CROSS-REFERENCE TO RELATED APPLICATIONS

This application claims priority of German patent application no. 10 2024 119 111.2, filed Jul. 5, 2024, the entire content of which is incorporated herein by reference.

### TECHNICAL FIELD

The present disclosure relates to a fuel-cell exhaust system, to a fuel cell system containing such a fuel-cell exhaust system and to a method for reducing the water content in the fuel-cell exhaust gas discharged by a fuel cell of a fuel cell system.

### BACKGROUND

When generating electrical energy in a fuel cell system, for example constructed with one or more PEM fuel cells, water is produced, in particular in the cathode area. This is generally carried along as water vapor in the cathode exhaust gas leaving the cathode area, which substantially provides the fuel-cell exhaust gas that is also to be discharged to the environment, and is discharged to the environment via a fuel-cell exhaust system. Especially at comparatively low ambient temperature, when fuel-cell exhaust gas with a high concentration of water vapor is discharged into the ambient air, mist is produced as a result of water condensing out due to the spontaneous lowering of the temperature of the fuel-cell exhaust gas when it comes into contact with the ambient temperature. This may impair visibility in the vicinity of a vehicle equipped with such a fuel cell system and may also cause ice to form on the ground in the area of a vehicle equipped with such a fuel cell system.

### SUMMARY

An object of the present disclosure is to provide a fuel-cell exhaust system, a fuel cell system constructed therewith and a method for reducing the water content in fuel-cell exhaust gas with which the discharge of fuel-cell exhaust gas into the environment such as to cause the formation of a large amount of mist is avoided while using a structurally simple configuration.

According to a first aspect of the present disclosure, this object is achieved by a fuel-cell exhaust system for a fuel cell system, in particular in a vehicle, including:
a heat exchanger arrangement with a first heat exchanger area, through which fuel-cell exhaust gas can flow, and a second heat exchanger area, through which cooling gas can flow, the first heat exchanger area and the second heat exchanger area being in heat transfer interaction for transferring heat from the fuel-cell exhaust gas to the cooling gas,
a mixing arrangement for receiving cooled fuel-cell exhaust gas discharged from the first heat exchanger area and heated cooling gas discharged from the second heat exchanger area in a mixing volume for producing a mixture of cooled fuel-cell exhaust gas and heated cooling gas and for discharging the mixture.

In a fuel-cell exhaust system of such a construction, the cooling of the fuel-cell exhaust gas via the cooling gas and the resulting heating of the cooling gas, as well as the subsequent mixing of these two gas streams, ensures that the mixture of fuel-cell exhaust gas and cooling air that is produced in this way and discharged to the environment is in a thermodynamic state which does not lead to a high level of condensation of water still contained in the fuel-cell exhaust gas, and an accompanying formation of mist, even in subsequent contact with comparatively cold ambient air.

In order to be able to conduct the various gas streams in the fuel-cell exhaust system according to the disclosure in a defined manner, it is proposed:
that the first heat exchanger area includes a first heat-exchanger inlet area for receiving fuel-cell exhaust gas and a first heat-exchanger outlet area for discharging cooled fuel-cell exhaust gas,
that the second heat exchanger area includes a second heat-exchanger inlet area for receiving cooling gas and a second heat-exchanger outlet area for discharging heated cooling gas,
that the mixing arrangement includes a first mixing-arrangement inlet area for receiving cooled fuel-cell exhaust gas discharged at the first heat-exchanger outlet area and a second mixing-arrangement inlet area for receiving heated cooling gas discharged at the second heat-exchanger outlet area.

Supplying the cooling gas to the heat exchanger arrangement also with the required mass flow can be ensured for example by providing a cooling-gas supply arrangement for supplying cooling gas to the second heat exchanger area. For example, the cooling-gas supply arrangement may include a blower or a compressor.

In order to be able to provide a sufficiently large amount of the cooling gas in a simple manner, the cooling-gas supply arrangement may be configured for supplying ambient air as cooling gas to the second heat exchanger area.

In order to be able to remove condensing-out water from the fuel-cell exhaust gas in the process of cooling the fuel-cell exhaust gas and the accompanying heating of the cooling gas and the subsequent merging of these gas streams, it is proposed that a water separation arrangement for separating water condensed out of the fuel-cell exhaust gas is provided.

For supplying dehydrated fuel-cell exhaust gas to the mixing arrangement, the water separation arrangement may be provided upstream of the mixing volume in the flow path of the fuel-cell exhaust gas.

Since the cooling of the fuel-cell exhaust gas is carried out in the area of the heat exchanger arrangement, it is particularly advantageous if the water separation arrangement is provided in the area of the first heat exchanger area.

For example, the water separation arrangement in association with the first heat exchanger area may include a water uptake volume and a third heat-exchanger outlet area for discharging water from the water uptake volume.

According to a further aspect of the present disclosure, the object stated at the beginning is achieved by a fuel cell system, in particular in a vehicle, including: at least one fuel cell with an anode area to be supplied with hydrogen-containing anode gas and a cathode area to be supplied with oxygen-containing cathode gas, a fuel-cell exhaust system of a construction according to the disclosure, the first heat exchanger area for receiving fuel-cell exhaust gas discharged at the cathode area of the at least one fuel cell being connected to the cathode area.

According to a further aspect of the present disclosure, the object stated at the beginning is achieved by a method for reducing the water content in fuel-cell exhaust gas produced in a fuel cell system, including the measures:
a) transferring heat from the fuel-cell exhaust gas to a cooling gas;
b) mixing the fuel-cell exhaust gas cooled by measure a) with at least part of the cooling gas heated by measure a);
c) discharging the mixture produced by measure b) to the environment.

In this method, measure a) may include supplying the fuel-cell exhaust gas to a first heat exchanger area of a heat exchanger arrangement and supplying the cooling gas to a second heat exchanger area of the heat exchanger arrangement, in order in this way to produce a thermal interaction of these two gas streams without already mixing them together.

For the mixing together of the two cooled or heated gas streams, measure b) may include supplying the cooled fuel-cell exhaust gas from the first heat exchanger area to a mixing arrangement and supplying the heated cooling gas from the second heat exchanger area to the mixing arrangement.

For emitting the substantially non-misting fuel-cell exhaust gas into the environment, measure c) may include discharging the mixture of cooled fuel-cell exhaust gas and heated cooling gas produced in the mixing arrangement.

In order to be able to take up water that condenses out during the thermal interaction of the two gas streams, it is proposed that measure a) includes a measure a1) for separating water that condenses out of the fuel-cell exhaust gas.

It may in this case be provided for example that measure a1) includes collecting water condensed out of the fuel-cell exhaust gas in a water uptake volume and discharging the water collected in the water uptake volume.

Efficient cooling of the fuel-cell exhaust gas can be ensured for example if in measure a) heat is transferred from the fuel-cell exhaust gas to ambient air as cooling gas.

For this purpose, the ambient air may be supplied to the second heat exchanger area via a cooling-gas supply arrangement.

The method according to the disclosure is advantageously carried out via a fuel-cell exhaust system of a construction according to the disclosure in a fuel cell system of a construction according to the disclosure containing this exhaust system.

### BRIEF DESCRIPTION OF DRAWINGS

The invention will now be described with reference to the drawings wherein:

FIG. 1 shows a fuel cell system with a fuel-cell exhaust system in a basic representation; and,

FIG. 2 shows a state diagram showing the thermodynamic state of the dehydrated fuel-cell exhaust gas discharged to the environment.

### DETAILED DESCRIPTION

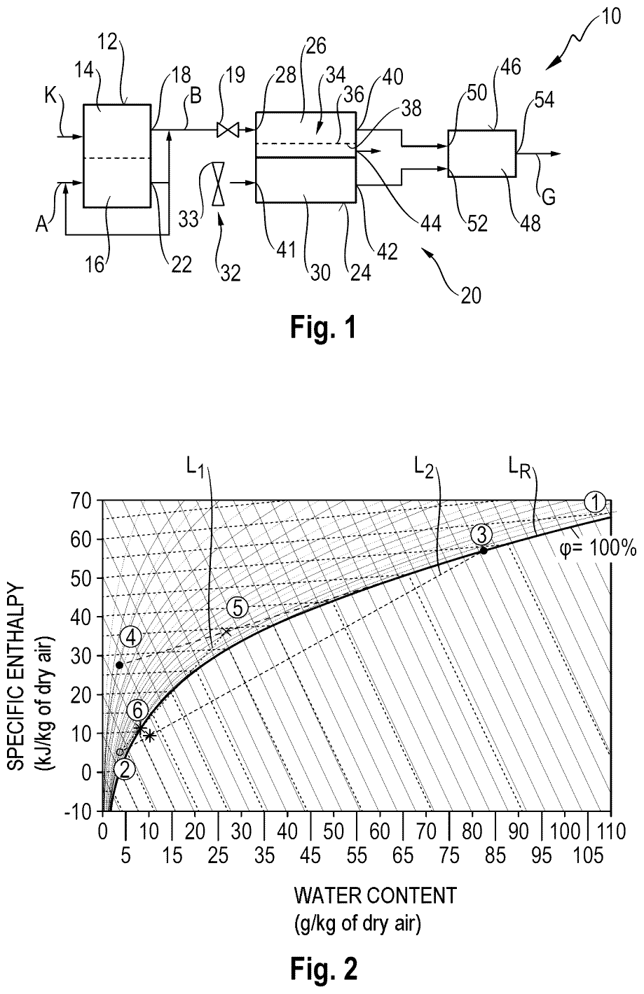

In FIG. 1, a fuel cell system, provided for example for generating electrical energy in a vehicle, is denoted generally by 10. The fuel cell system 10 includes a fuel cell unit 12, formed for example as a fuel cell stack or the like, with a cathode area 14 and an anode area 16. The cathode area 14 is supplied with a cathode gas K containing oxygen, for example air, by a compressor or the like. An anode gas A containing hydrogen (H₂) is supplied to the anode area 16.

A cathode exhaust gas produced in the fuel cell process leaves the cathode area 14 at a cathode-area outlet area 18 and flows for example via an optionally shut-off valve 19 in the direction of a fuel-cell exhaust system denoted generally by 20. At an anode-area outlet area 22, anode exhaust gas, escaping for example when performing a purging process, can be recycled into the working process, in order to be able to use the hydrogen contained therein to generate electrical energy, or/and can be supplied together with the cathode exhaust gas as fuel-cell exhaust gas B to the fuel-cell exhaust system 20.

In fuel cell operation, water is produced, in particular in the cathode area 14, and is generally carried along as water vapor in the cathode exhaust gas substantially containing oxygen and nitrogen. The content of the water or water vapor in the cathode exhaust gas can be comparatively great and close to complete saturation, that is, a relative humidity of 100%. If such a cathode exhaust gas containing a high proportion of water or water vapor is emitted to the environment as fuel-cell exhaust gas B, there is the risk that water will condense out, in particular at a comparatively low ambient temperature, when the fuel-cell exhaust gas B comes into contact with the cold ambient air, and thus mist will be produced.

In order to largely eliminate the risk of mist formation during the discharge of fuel-cell exhaust gas B in the fuel-cell exhaust system 20 shown in FIG. 1 or the fuel cell system 10 having this exhaust system, the fuel-cell exhaust system 20 includes a heat exchanger arrangement denoted generally by 24. The fuel-cell exhaust gas B substantially provided by the cathode exhaust gas is supplied to a first heat exchanger area 26 of the heat exchanger arrangement 24 at a first heat-exchanger inlet area 28. Preferably air is supplied as cooling gas L to a second heat exchanger area 30 of the heat exchanger arrangement 24 via a cooling-gas supply arrangement 32 at a second heat-exchanger inlet area 41. The cooling-gas supply arrangement 32 may include for example a blower or a compressor 33 and may receive the air to be used as cooling gas L from the environment of the fuel cell system 10 or from the environment of a vehicle and pass it on to the second heat exchanger area 30.

The fuel-cell exhaust gas B flows through the first heat exchanger area 26, while at the same time the cooling gas L flows through the second heat exchanger area 30. A thermal interaction of these two fundamentally separate gas streams is thereby produced in the area of the heat exchanger arrangement 24, by which the fuel-cell exhaust gas B at a temperature in the range of up to 100° C. is cooled by the cooling gas L generally at ambient temperature, and thus significantly colder, while at the same time the cooling gas L is heated.

In this process of cooling the fuel-cell exhaust gas B in the first heat exchanger area 26, the degree of saturation of the fuel-cell exhaust gas B reaches a value of 100%, so that at least a part of the water W carried along in the fuel-cell exhaust gas B in the form of water vapor condenses out. In order to discharge this condensing-out water W, the first heat exchanger area 26 has an associated water separation arrangement denoted generally by 34. This may for example include a water uptake volume 38 separated by a wall 36 provided with openings, in which the water W condensing out during the cooling of the fuel-cell exhaust gas B can accumulate.

The cooled and dehydrated fuel-cell exhaust gas B leaves the first heat exchanger area 26 via a first heat-exchanger outlet area 40. The cooling gas L heated by the thermal interaction with the fuel-cell exhaust gas B leaves the second heat exchanger area 30 via a second heat-exchanger outlet area 42. The water W accumulated in the water uptake volume 36 can be drained from the water uptake volume 38 for example continuously or at defined times at a third heat exchanger outlet region 44 and either discharged in liquid form to the environment or for example fed back into the fuel cell process.

The fuel-cell exhaust system 20 further includes a mixing arrangement 46. The mixing arrangement 46 includes a mixing volume 48 which is formed in a housing and into which the cooled and dehydrated fuel-cell exhaust gas B enters at a mixing-arrangement inlet area 50 and the heated cooling gas L enters at a second mixing-arrangement inlet area 52. In the mixing volume 48, these two gas streams mix together, so that at a mixing-arrangement outlet area 54 a mixture G of cooled and dehydrated fuel-cell exhaust gas B and heated cooling gas L can be discharged from the mixing arrangement 46 and for example be emitted to the environment.

With reference to FIG. 2, it is explained below how the thermodynamic states of the various gas streams change or adjust in the course of the flow through the fuel-cell exhaust system 20.

It should initially be assumed here that, at point 1, the fuel-cell exhaust gas B discharged by the fuel cell 12, which has a relatively high water content, is in a state in which it has a comparatively great specific enthalpy, that is, a comparatively high temperature, and a relative humidity close to 100%. The ambient air used as cooling gas L has a comparatively low specific enthalpy and thus a comparatively low temperature and also a comparatively low water content. The relative humidity of the ambient air is less than 100%.

When it flows through the heat exchanger arrangement 24 and there is the resulting thermal interaction between the fuel-cell exhaust gas B and the cooling gas L, the state of the fuel-cell exhaust gas B changes in the direction of point 3. Since a state with a relative humidity of 100% cannot be exceeded, in the course of the cooling of the fuel-cell exhaust gas B water W condenses out and can be collected, for example in the water uptake volume 36.

During this thermal interaction in the heat exchanger arrangement 24, the ambient air used as cooling gas L heats up from point 2 to the state at point 4. The water content in the ambient air does not change. It merely increases its temperature and thus the specific enthalpy.

If these two gas streams are subsequently mixed in the mixing arrangement 46, a thermodynamic state of the mixture G represented by point 5 is produced. Due to the comparatively great water content in the fuel-cell exhaust gas B entering the mixing arrangement 46, the water content of the mixture G is greater than the water content of the heated cooling gas L. Similarly, due to the still comparatively high temperature of the fuel-cell exhaust gas B discharged from the first heat exchanger area 26, the temperature of the mixture G at point 5 is higher than the temperature of the cooling gas L at point 4, that is, when leaving the second heat exchanger area 30.

If the mixture G is subsequently discharged to the environment, due to thermal contact with the ambient air it will assume a state in which both the temperature and the water content of the mixture G will adapt to the corresponding values of the ambient air, so that the mixture G enters the state represented by point 2.

It can be clearly seen in FIG. 2 that, at the transition from the state at point 5 to the state at point 2, substantially along a line L1, the hypothetical undershooting of the line LR representing the relative humidity of 100% is significantly less pronounced than in a state in which the fuel-cell exhaust gas B cooled in the first heat exchanger area 26 and already depleted of water W would have approached the state of point 2 from the state of point 3 along a hypothetical line L2. This means that, when the mixture G escapes to the environment, almost no water will condense out of the mixture G. This is due to the fact that, at the transition from the state of point 1 to the state of point 3, a significant amount of the water or water vapor initially carried along in the fuel-cell exhaust gas B has already been condensed out and that subsequently, due to the mixing of the cooled and dehydrated fuel-cell exhaust gas B together with the heated cooling gas L, the relative humidity of the mixture thus produced has been lowered.

With the process carried out in the fuel-cell exhaust system 20 for cooling the fuel-cell exhaust gas B and the resulting discharge of water from this exhaust system, as well as the subsequent mixing of the cooled and dehydrated fuel-cell exhaust gas B together with the cooling gas L previously used for cooling the fuel cell gas B and thereby heated, it becomes possible with simple structural measures to largely avoid the condensing out of water and an accompanying formation of mist when fuel-cell exhaust gas is emitted to the environment.

It should be noted that the fuel-cell exhaust system may also be configured in a different manner than shown in FIG. 1. For example, the heat exchanger arrangement 24 and the mixing arrangement 46 may be structurally combined and housed in a housing in which separate volumes, which are open to the mixing volume 48 via respective openings, channels or the like, are provided for the first heat exchanger area 26 and the second heat exchanger area 30. The water separation arrangement 34 may also be provided downstream of the heat exchanger arrangement 24, for example integrated in the mixing arrangement 46, but upstream of the mixing volume 48. The fuel-cell exhaust system may also include further system areas, such as for example a silencer or the like, for example downstream of the mixing arrangement 46, so that the mixture G from the mixing arrangement 46 is not discharged to the environment directly, but via such further system areas.

It is understood that the foregoing description is that of the preferred embodiments of the invention and that various changes and modifications may be made thereto without departing from the spirit and scope of the invention as defined in the appended claims.

1. A fuel-cell exhaust system for a fuel cell system, the fuel-cell exhaust system comprising:
a heat exchanger arrangement having a first heat exchanger area wherethrough fuel-cell exhaust gas can flow, and a second heat exchanger area wherethrough cooling gas can flow;
said first heat exchanger area and said second heat exchanger area being in heat transfer interaction for transferring heat from the fuel-cell exhaust gas to the cooling gas; and,
a mixing arrangement for receiving cooled fuel-cell exhaust gas discharged from said first heat exchanger area and heated cooling gas discharged from said second heat exchanger area in a mixing volume for producing a mixture of cooled fuel-cell exhaust gas and heated cooling gas and for discharging the mixture.

2. The fuel-cell exhaust system of claim 1, wherein:
said first heat exchanger area includes a first heat-exchanger inlet area for receiving fuel-cell exhaust gas and a first heat-exchanger outlet area for discharging cooled fuel-cell exhaust gas;
said second heat exchanger area includes a second heat-exchanger inlet area for receiving cooling gas and a second heat-exchanger outlet area for discharging heated cooling gas; and,
said mixing arrangement includes a first mixing-arrangement inlet area for receiving cooled fuel-cell exhaust gas discharged at said first heat-exchanger outlet area and a second mixing-arrangement inlet area for receiving heated cooling gas discharged at the second heat-exchanger outlet area.

3. The fuel-cell exhaust system of claim 1, wherein a cooling-gas supply arrangement for supplying cooling gas to said second heat exchanger area is provided.

4. The fuel-cell exhaust system of claim 3, wherein said cooling-gas supply arrangement includes a blower or a compressor.

5. The fuel-cell exhaust system of claim 3, wherein said cooling-gas supply arrangement is configured for supplying ambient air as cooling gas to the second heat exchanger area.

6. The fuel-cell exhaust system of claim 1, wherein a water separation arrangement for separating water condensed out of the fuel-cell exhaust gas is provided.

7. The fuel-cell exhaust system of claim 6, wherein the water separation arrangement is provided upstream of the mixing volume in the flow path of the fuel-cell exhaust gas.

8. The fuel-cell exhaust system of claim 6, wherein said water separation arrangement is provided in the area of said first heat exchanger area.

9. The fuel-cell exhaust system of claim 8, wherein said water separation arrangement in association with said first heat exchanger area includes a water uptake volume and a third heat-exchanger outlet area for discharging water from the water uptake volume.

10. A fuel cell system comprising:
at least one fuel cell having an anode area to be supplied with hydrogen-containing anode gas and a cathode area to be supplied with oxygen-containing cathode gas;
a fuel-cell exhaust system including a heat exchanger arrangement having a first heat exchanger area wherethrough fuel-cell exhaust gas can flow, and a second heat exchanger area wherethrough cooling gas can flow; said first heat exchanger area and said second heat exchanger area being in heat transfer interaction for transferring heat from the fuel-cell exhaust gas to the cooling gas; and, a mixing arrangement for receiving cooled fuel-cell exhaust gas discharged from said first heat exchanger area and heated cooling gas discharged from said second heat exchanger area in a mixing volume for producing a mixture of cooled fuel-cell exhaust gas and heated cooling gas and for discharging the mixture; and,
said first heat exchanger area for receiving fuel-cell exhaust gas discharged at the cathode area of said at least one fuel cell being connected to said cathode area.

11. A method for reducing water content in fuel-cell exhaust gas produced in a fuel cell system, the method comprising the steps of:
a) transferring heat from the fuel-cell exhaust gas to a cooling gas;
b) mixing the fuel-cell exhaust gas cooled via step a) with at least part of the cooling gas heated by step a); and,
c) discharging the mixture produced by step b) to the environment.

12. The method of claim 11, wherein step a) comprises supplying the fuel-cell exhaust gas to a first heat exchanger area of a heat exchanger arrangement and supplying the cooling gas to a second heat exchanger area of the heat exchanger arrangement.

13. The method of claim 12, wherein step b) comprises supplying the cooled fuel-cell exhaust gas from the first heat exchanger area to a mixing arrangement and supplying the heated cooling gas from the second heat exchanger area to the mixing arrangement.

14. The method of claim 13, wherein step c) comprises discharging the mixture of cooled fuel-cell exhaust gas and heated cooling gas produced in the mixing arrangement.

15. The method of claim 11, wherein step a) comprises a step a1) for separating water condensing out of the fuel-cell exhaust gas.

16. The method of claim 15, wherein step a1) comprises collecting water condensed out of the fuel-cell exhaust gas in a water uptake volume and discharging the water collected in the water uptake volume.

17. The method of claim 12, wherein in step a) heat is transferred from the fuel-cell exhaust gas to ambient air as a cooling gas.

18. The method of claim 17, wherein the ambient air is supplied to the second heat exchanger area via a cooling-gas supply arrangement.

19. The method of claim 11, wherein the method is carried out by a fuel-cell exhaust system in a fuel cell system;
the fuel-cell exhaust system including: a heat exchanger arrangement having a first heat exchanger area wherethrough fuel-cell exhaust gas can flow, and a second heat exchanger area wherethrough cooling gas can flow; said first heat exchanger area and said second heat exchanger area being in heat transfer interaction for transferring heat from the fuel-cell exhaust gas to the cooling gas; and, a mixing arrangement for receiving cooled fuel-cell exhaust gas discharged from said first heat exchanger area and heated cooling gas discharged from said second heat exchanger area in a mixing volume for producing a mixture of cooled fuel-cell exhaust gas and heated cooling gas and for discharging the mixture; and,
said fuel cell system including: at least one fuel cell having an anode area to be supplied with hydrogen-containing anode gas and a cathode area to be supplied with oxygen-containing cathode gas.

20. The fuel-cell exhaust system of claim 1, wherein said fuel-cell exhaust system is for a vehicle.

21. The fuel cell system of claim 10, wherein said fuel cell system is for a vehicle.
